(19) United States
(12) Patent Application Publication
(10) Pub. No.: US 2026/0316384 A1
(43) Pub. Date: Oct. 15, 2026

(54) A method for improved adhesion of polymers to the receiver item during 3D printing

(71) Applicant: SIGNIFY HOLDINGB.V., EINDHOVEN (NL)

(72) Inventors: RIFAT ATA MUSTAFA HIKMET, EINDHOVEN (NL); TIES VAN BOMMEL, HORST (NL)

(21) Appl. No.: 19/484,395

(22) PCT Filed: May 28, 2024
(86) PCT No.: PCT/EP2024/064635

§ 371 Date: Nov. 14, 2025

(30) Foreign Application Priority Data
Jun. 8, 2023 (EP) 23178179.0

(51) Int. Cl. B29C 64/245; B29C 64/295; B29L 31/00; B33Y 10/00; B33Y 30/00; B33Y 40/00; B33Y 80/00; C09D 123/12; C09D 125/06; C09D 167/02; C09D 167/04; C09D 177/02

(52) U.S. Cl. CPC B29C 64/245; B29C 64/295; B33Y 30/00; B33Y 40/00; B33Y 80/00; C09D 123/12; C09D 125/06; C09D 167/02; C09D 167/04; C09D 177/02; B29K 2995/0039; B29L 2031/747; B33Y 10/00

(57) ABSTRACT

The invention provides a method for producing a 3D item (1) by means of 3D printing using a 3D printer (500), wherein the 3D printer (500) has a receiver item (550) which can be heated to a receiver item temperature. The method comprises the steps of providing a receiver item (550) having an adhesion layer (222) made of a first 3D printable material (201), the first 3D printable material (201) comprising a thermoplastic amorphous polymer having a first glass transition temperature TG1. Selecting a second receiver item temperature TR2 above the first glass transition temperature; and printing the 3D item (1) on top of the adhesion layer (220) using a second 3D printable material (201). The second 3D printable material (201) comprises a thermoplastic polymer having a second glass transition temperature TG2 and/or a second melting temperature TM2, wherein TG2>TR2>TG1 and/or TM2>TR2>TG1, and the second 3D printable material (201) being non-miscible with the first 3D printable material (201). Cooling down the receiver item (550) to a third receiver item temperature TR3, wherein TR3<TG1, and removing the 3D item (1) from the adhesion layer (222).

### FIELD OF THE INVENTION

The invention relates to a method of manufacturing an object by means of 3D printing, in particular by means of fused deposition modelling. The invention also relates to an object obtainable with such a method of manufacturing, and to a lighting device comprising such an object.

### BACKGROUND OF THE INVENTION

Digital manufacturing is expected to increasingly transform the nature of global manufacturing. One of the main processes used in digital manufacturing is 3D printing. The term “3D printing” refers to processes wherein a material is joined or solidified under computer control to create a three-dimensional object of almost any shape or geometry. Such three-dimensional objects are typically produced using data from a three-dimensional model, and usually by successively adding material layer by layer.

Many different 3D printing technologies are known in the art.

FDM, also called fused filament fabrication (FFF) or filament 3D printing (FDP), is one of the most commonly used forms of 3D printing. In an FDM process, a 3D printer creates an object in a layer-by-layer manner by extruding a printable material (typically a filament of a thermoplastic material) along tool paths that are generated from a digital representation of the object. The printable material is heated just beyond solidification and extruded through a nozzle of a print head of the 3D printer. The extruded printable material fuses to previously deposited material and solidifies upon a reduction in temperature. In a typical 3D printer, the printable material is deposited as a sequence of planar layers onto a substrate that defines a build plane. The position of the print head relative to the substrate is then incremented along a print axis (perpendicular to the build plane), and the process is repeated until the object is complete.

FDM printers are relatively fast, low cost and can be used for printing complicated three-dimensional objects. Such printers are used in printing various shapes using various 3D printable materials. The technique is also being further developed in the production of LED luminaires and lighting solutions.

One of the challenges of FDM printing is the adhesion of the 3D printed item to the receiver item. Methods for improving adhesion during printing are known in the art.

WO2018/015192, for instance, describes a method for 3D printing a 3D item, wherein, during an initial printing stage, a layer of a first 3D printable material is deposited on the receiver item, onto which, during a main printing stage, a second 3D printable material is deposited to complete the 3D item. The first and the second 3D printable material are chosen to be compatible (miscible) and form one connected 3D printed item.

### SUMMARY OF THE INVENTION

Producing 3D items from thermoplastic materials having a high melting temperature is challenging. Such 3D items tend to detach from the receiver item during printing and can often only be printed using large brims or using glues, which need to be removed manually after printing the 3D item. Hence, it is an aspect of the invention to provide an alternative 3D printing method which preferably further at least partly obviate(s) one or more of above-described drawbacks. The present invention may have as object to overcome or ameliorate at least one of the disadvantages of the prior art, or to provide a useful alternative.

In a first aspect the invention provides a method for producing a 3D item by means of 3D printing using a 3D printer, wherein the 3D printer has a receiver item which can be heated to a receiver item temperature. The method comprises the steps of:
providing the receiver item having an adhesion layer made of a first 3D printable material, the first 3D printable material comprising a thermoplastic amorphous polymer having a first glass transition temperature TG1;
selecting a second receiver item temperature TR2 above the first glass transition temperature TG1 (step B); and
printing the 3D item on top of the adhesion layer using a second 3D printable material, the second 3D printable material comprising a thermoplastic polymer having a second glass transition temperature TG2 and/or a second melting temperature TM2, wherein TG2>TR2>TG1 and/or TM2>TR2>TG1, and
the second 3D printable material being non-miscible with the first 3D printable material;
cooling down the receiver item to a third receiver item temperature TR3, wherein TR3<TG1; and
removing the 3D item from the adhesion layer.

This invention provides a universal method for preventing a 3D item from detaching from the receiver item during printing. Even 3D printable materials which are typically challenging to print due to their poor adhesion to the receiver item may be successfully printed using the method of this invention. During printing of the 3D item, the adhesion layer is kept in a rubbery state. The adhesion layer in its rubbery state provides the mechanical adhesion needed for the 3D item to be printed, but once cooled down the 3D item and the adhesion layer can be separated due their non-miscibility. The method additionally allows printing 3D items at lower receiver item temperatures, saving energy during printing and thus contributing to sustainability objectives.

As indicated above, the method comprises depositing 3D printable material. Herein, the term “3D printable material” refers to the material to be deposited or printed, and the term “3D printed material” refers to the material that is obtained after deposition. These materials may be essentially the same, as the 3D printable material may especially refer to the material in a printer head or extruder at elevated temperature and the 3D printed material refers to the same material, but in a later stage when deposited. In embodiments, the 3D printable material may be printed as a filament and deposited as such. The 3D printable material may be provided as filament or may be formed into a filament. Hence, whatever starting materials are applied, a filament comprising 3D printable material may be provided by the printer head and 3D printed. The term “extrudate” may be used to define the 3D printable material downstream of the printer head, but not yet deposited. The latter may be indicated as “3D printed material”. In fact, the extrudate may be considered to comprise 3D printable material, as the material is not yet deposited. Upon deposition of the 3D printable material or extrudate, the material may thus be indicated as 3D printed material. Essentially, the materials may be the same material, as the thermoplastic material upstream of the printer head, downstream of the printer head, and when deposited, may essentially be the same material(s).

Herein, the term “3D printable material” may also be indicated as “printable material”. The term “polymeric material” may in embodiments refer to a blend of different polymers, but may in embodiments also refer to essentially a single polymer type with different polymer chain lengths. Hence, the terms “polymeric material” or “polymer” may refer to a single type of polymers but may also refer to a plurality of different polymers. The term “printable material” may refer to a single type of printable material but may also refer to a plurality of different printable materials. The term “printed material” may refer to a single type of printed material but may also refer to a plurality of different printed materials.

Hence, the term “3D printable material” may also refer to a combination of two or more materials. In general, these (polymeric) materials have a glass transition temperature T_{g} and/or a melting temperature Tₘ. The 3D printable material will be heated by the 3D printer before it leaves the nozzle to a temperature of at least the glass transition temperature, and in general at least the melting temperature. Hence, in a specific embodiment the 3D printable material comprises a thermoplastic polymer having a glass transition temperature (T_{g}) and/or a melting point (Tₘ), and the printer head action may comprise heating the 3D printable material above the glass transition and in embodiments above the melting temperature (especially when the thermoplastic polymer is a semi-crystalline polymer). In yet another embodiment, the 3D printable material comprises a (thermoplastic) polymer having a melting point (Tₘ), and the 3D printing stage may comprise heating the 3D printable material to be deposited on the receiver item to a temperature of at least the melting point. The glass transition temperature is in general not the same thing as the melting temperature. Melting is a transition which may occur in crystalline polymers. Melting may happen when the polymer chains fall out of their crystal structures, and become a disordered liquid. The glass transition may be a transition which happens to amorphous polymers; that is, polymers whose chains are not arranged in ordered crystals, but are just strewn around in any fashion, even though they are in the solid state. Polymers can be amorphous, essentially having a glass transition temperature and not a melting temperature or can be (semi) crystalline, in general having both a glass transition temperature and a melting temperature, with in general the latter being larger than the former. The glass temperature may e.g. be determined with differential scanning calorimetry. The melting point or melting temperature can also be determined with differential scanning calorimetry.

The term 3D printable material is further also elucidated below, but may especially refer to a thermoplastic material, optionally including additives, to a volume percentage of at maximum about 60%, especially at maximum about 30 vol. %, such as at maximum 20 vol. % (of the additives relative to the total volume of the thermoplastic material and additives).

The printable material may thus in embodiments comprise two phases. The printable material may comprise a phase of printable polymeric material, especially thermoplastic material (see also below), which phase is especially an essentially continuous phase. In this continuous phase of thermoplastic material polymer additives such as one or more of antioxidant, heat stabilizer, light stabilizer, ultraviolet light stabilizer, ultraviolet light absorbing additive, near infrared light absorbing additive, infrared light absorbing additive, plasticizer, lubricant, release agent, antistatic agent, anti-fog agent, antimicrobial agent, colorant, laser marking additive, surface effect additive, radiation stabilizer, flame retardant, anti-drip agent may be present. The additive may have useful properties selected from optical properties, mechanical properties, electrical properties, thermal properties, and mechanical properties (see also above).

The printable material in embodiments may comprise particulate material, i.e. particles embedded in the printable polymeric material, which particles form a substantially discontinuous phase. The number of particles in the total mixture may especially not be larger than 60 vol. %, relative to the total volume of the printable material. For optical and surface related effect number of particles in the total mixture is equal to or less than 20 vol. %, such as up to 10 vol. %, relative to the total volume of the printable material (including the particles). Hence, the 3D printable material may especially refer to a continuous phase of essentially thermoplastic material, wherein other materials, such as particles, may be embedded. Likewise, the 3D printed material especially refers to a continuous phase of essentially thermoplastic material, wherein other materials, such as particles, are embedded. The particles may comprise one or more additives as defined above. Hence, in embodiments the 3D printable materials may comprises particulate additives.

The method of the invention may also be desirable for 3D printing core-shell layers wherein the shell printable material comprises a semi-crystalline polymer. When using a core-shell nozzle, the 3D printable material provided to the core of the core-shell nozzle may be a filament comprising 3D printable material or may be particulate 3D printable material. Both type of feeds may be extruded via the core of the core-shell nozzle. The 3D printable material provided to a shell of the core-shell nozzle may be particulate 3D printable material. Such particulate 3D printable material (feed) may be extruded via the shell of the core-shell nozzle. When using a nozzle with a single opening, the 3D printable material provided to nozzle may be a filament comprising 3D printable material or may be particulate 3D printable material. Both type of feeds may be extruded via the nozzle.

The first 3D printable material comprises a thermoplastic amorphous polymer. The 3D printable material comprises a thermoplastic material of the semi-crystalline type. Hence, the 3D printable material may have substantially no crystallinity, i.e. is amorphous, but is able to crystallize, i.e. become a semi-crystalline polymer with crystallinity and amorphous features, as is known in the art. In the amorph state, or the state of low crystallinity, there is a randomly ordered molecular structure.

Examples of materials that may be suitable as first 3D printable material in this invention include, but are not limited to, polyethylene (PE), low-density polyethylene (LDPE), medium-density polyethylene (MDPE), high-density polyethylene (HDPE), polypropylene (PP), polyamides (PA), polycaprolactone (PCL), polylactic acid (PLA) polyvinyl alcohol (PVA), polyvinylidene fluoride (PVDF), crystalline polyethylene terephthalate (cPET), polycarbonate (PC), polystyrene (PS), polymethylmethacrylate (PMMA), polybutylene terephthalate (PBT), polyhydroxyalkanoates (PHAs), and polybutylene succinate (PBS), aromatic polyesters, such as polyethylene terephthalate (PET), polycyclohexylenedimethylene terephthalate (PCT), polyethylene terephthalate glycol (PETG), polybutylene terephthalate (PBT), polyethylene naphthalene (PEN) and their copolymers, polyphenylene sulfide (PPS), syndiotactic polystyrene (sPS), etc.

The second 3D printable material comprises a thermoplastic polymer having a second glass transition temperature and/or a second melting temperature. At least one of the second glass transition temperature or the second melting temperature is higher than the glass transition temperature of the first 3D printable material.

The second 3D printable material comprises a (thermoplastic) polymer. Examples of thermoplastic polymers include polystyrenes (such as acrylonitrile butadiene styrene (ABS)), polyamides (such as nylon), polyacetates, polyesters (such as polylactic acid (PLA) and polyethylene terephthalate (PET)), polyacrylates (such as polymethylacrylate, Perspex, polymethylmethacrylate (PMMA)), polyethylenes (such as low-density polyethylene (LDPE) and high-density polyethylene (HDPE)), polypropylenes, polyvinyl chloride (PVC), polycarbonate (PC), Polychloroethene, sulfide containing polymers (such as polysulfone), and thermoplastic elastomers based on copolyester elastomers, polyurethane elastomers, polyamide elastomers polyolefine based elastomers, styrene based elastomers, etc.

The first 3D printable material and the second 3D printable material are non-miscible, or in other words immiscible, not miscible, or non-compatible. Miscibility or compatibility of polymers is a concept and term which is well understood in the art. These effects are known to the skilled person and definitions can for example be found in the book “Polymer-Polymer Miscibility” by Olagoke Olabisi et al. (1979, Academic Press, New York, N.Y., ISBN: 0-12-525050-9).

The term miscibility is used to describe the ability of a mixture containing two or more components to form a one-phase (solid or liquid), homogeneous system. Components are said to be non-miscible if there are certain properties in which the mixture does not form a homogeneous system. The interaction between polymer-polymer pairs affects the physical and mechanical properties of miscible systems and, for immiscible ones, it determines the nature and the width of the interface between the two polymers. In other words, the first 3D printable material and the second 3D printable material do not form a chemical bond and the two materials do not mix.

The printable material may be printed on a receiver item or build plate. Especially, the receiver item can be the building platform or can be comprised by the building platform. The receiver item can also be heated during 3D printing. However, the receiver item may also be cooled during 3D printing.

The phrase “printing on a receiver item” and similar phrases include amongst others directly printing on the receiver item, or printing on a coating on the receiver item, or printing on 3D printed material earlier printed on the receiver item. The term “receiver item” may refer to a printing platform, a print bed, a substrate, a support, a build plate, or a building platform, etc. Instead of the term “receiver item” also the term “substrate” may be used. The phrase “printing on a receiver item” and similar phrases include amongst others also printing on a separate substrate on or comprised by a printing platform, a print bed, a support, a build plate, or a building platform, etc. Therefore, the phrase “printing on a substrate” and similar phrases include amongst others directly printing on the substrate, or printing on a coating on the substrate or printing on 3D printed material earlier printed on the substrate. Here below, further the term substrate is used, which may refer to a printing platform, a print bed, a substrate, a support, a build plate, or a building platform, etc., or a separate substrate thereon or comprised thereby.

The receiver item has an adhesion layer. Different aspects and implementations of the adhesion layer will be described in further detail below. The adhesion layer is made of the first 3D printable material, thus comprises a thermoplastic amorphous polymer. The receiver item can be supplied already having the adhesion layer, such as having a coating or being laminated with a material comprising a thermoplastic amorphous polymer. Alternatively, the adhesion layer can be deposited as a thin layer of material on the receiver item using the 3D printer. In other words, the adhesion layer is an interface between the 3D item and the receiver item with the purpose to provide good adhesion of the 3D item to the receiver item during printing.

Layer by layer printable material may be deposited, by which the 3D printed item may be generated (during the printing stage). The 3D printed item may show characteristic ribbed structures (originating from the deposited filaments). However, it may also be possible that after a printing stage, a further stage is executed, such as a finalization stage. This stage may include removing the printed item from the receiver item and/or one or more post processing actions. One or more post processing actions may be executed before removing the printed item from the receiver item and/or one more post processing actions may be executed after removing the printed item from the receiver item. Post processing may include e.g. one or more of polishing, coating, adding a functional component, etc. Post-processing may include smoothening the ribbed structures, which may lead to an essentially smooth surface.

During the execution of the method of this invention, several different receiver item temperatures are chosen. In step B and step C the receiver item has a second receiver item temperature above the glass transition temperature of the first 3D printable material.

The second receiver item temperature may be at least 5 °C above the first glass transition temperature, such as 10 °C above the first glass transition temperature, preferably between 20 °C and 30 °C above the first glass transition temperature. At such receiver item temperatures, the first 3D printable material comprised by the adhesion layer may be kept at least partially melted or in a rubbery state. In such a state, the material may behave like a gum, which is a liquid with extremely high viscosity, to enable adhesion to the receiver item.

During step C of the method, the method may comprise depositing second 3D printable material on the adhesion layer to provide the 3D item. The 3D item may be created by depositing a stack of n layers. Especially, wherein n≥1, such as n≥3, like n≥5, such as n≥10. Essentially, step C of the method (printing the 3D item) is a “standard” 3D printing stage, except that it is executed on top of the non-miscible adhesion layer.

After printing the 3D item is completed (step C), the receiver item is cooled down to a third receiver item temperature in step D. The third receiver item temperature is lower than the first glass transition temperature. The third receiver item temperature may be at least 10 °C below the first glass transition temperature, like 50 °C below, such as room temperature.

At temperatures below the first glass transition temperature the adhesion layer solidifies and hardens, or in other words is in its glassy state. The first 3D printable material and the second 3D printable are non-miscible, thus the first 3D printed material and the second 3D printed material are non-miscible. Therefore, the two materials do not form a chemical bond and the two materials do not mix. Once the 3D item and the adhesion layer cool down below their respective glass transition temperature and/or melting temperature (if the material does not have a glass transition temperature), the 3D item and the adhesion layer can be easily separated, and the 3D item can be removed from the adhesion layer. The receiver item with the adhesion layer may be heated again and the adhesion layer may be reused.

In examples, the step of providing the receiver item having an adhesion layer (step A) may consist of two steps or sub-steps. First, a first receiver item temperature TR1 may be selected, wherein TR1≥TR2>TG1 (step A1), and subsequently a layer of first 3D printable material may be deposited (step A2) on the receiver item to provide the adhesion layer.

As already stated above, instead of supplying a receiver item already having an adhesion layer, the adhesion layer may alternatively be printed onto the receiver item using the first 3D printable material as part of the method of this invention. This may be advantageous since the material of the adhesion layer may be more easily adjusted to the to be printed 3D item, such as adjusted to the second 3D printable material used for the 3D item. It is not needed to have multiple different receiver items with different coatings if it is desired to print 3D items using different materials.

The first receiver item temperature may be at least 10 °C higher than the second receiver item temperature, such as 20 °C, preferably 30 °C above the second receiver item temperature.

It may be beneficial for printing the adhesion layer to have a higher build plate temperature than during printing of the 3D item. The first build plate temperature may be chosen higher than the first build plate temperature being higher than the first glass transition temperature. The first build plate temperature may be chosen such that it enables good adhesion of the adhesion layer to the receiver item.

Subsequently the receiver item temperature may be lowered for printing the 3D item, but preferably not below the first glass transition temperate. The second receiver item temperature may thus be at least 5 °C, such as at least 10 °C, preferably at least 15 °C above the first glass transition temperature TG1.

In examples, the method may additionally comprise the step of removing the adhesion layer from the receiver item after removing the 3D item.

A 3D printed adhesion layer may be removed from the receiver item after printing and removing the 3D item. In a next printing process a new adhesion layer may be printed for printing a new 3D item. Alternatively, the adhesion layer may remain on the receiver item after removing the 3D item and a new 3D item can be printed again on the adhesion layer. An adhesion layer may thus be reused for multiple print cycles, such as for example at least five print cycles.

The method may, prior to removing the 3D item from the adhesion layer, additionally comprise the step of removing the adhesion layer from the receiver item, wherein the adhesion layer is connected to the 3D item.

Removing the adhesion layer from the receiver item together with the 3D item, and then subsequently removing the 3D item from the adhesion layer may be beneficial for specific choices of 3D printable materials.

The adhesion layer may have a height H of less than or equal to 5 mm, such as less than or equal to 2 mm, preferably less than or equal to 3 mm.

The height or thickness of the adhesion layer may be chosen such that it provides good adhesion and stability for the 3D item during printing. Additionally, the height may be kept to a minimum to reduce waste of the first 3D printable material, since an adhesion layer may be discarded after printing or after a certain number of print cycles.

The adhesion layer may have a width W and wherein W/H is at least 3, such as at least 5, preferably at least 10.

It may be beneficial for the adhesion of the adhesion layer to the receiver item and/or for the adhesion of the 3D item to the adhesion layer, to have a width of the adhesion layer which is multiple times the height of the adhesion layer.

The second glass transition temperature and/or the second melting temperature may be above 120 °C, and the second glass transition temperature and/or the second melting temperature may be at least 20 °C, such as at least 30 °C, preferably at least 50 °C higher than the first glass transition temperature.

Using the method of this invention may be especially beneficial for printing 3D items made of 3D printable materials which are challenging to print using standard printing methods. These 3D printable materials may typically be materials with high glass transition temperatures and/or high melting temperatures, which would require high receiver item temperatures using standard printing methods. These 3D printable materials may also typically be materials that adhere poorly to the receiver item using standard printing methods and may e.g. only be printed using a large brim which may require manual removal after printing is completed. 3D items printed with such 3D printable materials may benefit most from the method of this invention, since they may be combined with a non-miscible 3D printable material in the adhesion layer, which may for example have a significantly lower glass transition temperature and/or melting temperature, thus enabling printing a significantly lower receiver item temperatures.

The first 3D printable material and the second 3D printable material are immiscible. Thus, the two 3D printable materials may be chosen from groups of materials which are generally known to be immiscible or have been found to be immiscible. Since immiscibility of polymers is desired in the method of this invention, the first and second 3D printable materials may be free of compatibilizers. Compatibilizers are additives which either chemically or physically react with the components in order to improve miscibility.

In examples, one of the first 3D printable material and the second 3D printable material may be a polar polymer, and the other may be a non-polar polymer. In general, it is known in the art that polar polymers and non-polar (or a-polar) polymers may not mix.

In other examples, both the first 3D printable material and the second 3D printable material may be semicrystalline polymers. In general, it is known in the art that semicrystalline polymers may not co-crystallize with other polymers.

Certain combinations of 3D printable materials may be especially suitable for use in the method of this invention. The first 3D printable material may comprise one or more of PLA, PET, PC, PS, or PMMA and their co-polymers, and/or the second 3D printable material may comprise one or more of polyamide (nylon PA6), PP, PE, or PHA.

The receiver item may have a receiver item surface area SAr, and the 3D item may have a footprint having a footprint surface area SAfp. The adhesion layer may cover a first surface area SA1 of the receiver item surface area Sar. The first surface area may be smaller than or equal to the receiver item surface area and the first surface area may be either equal to the footprint surface area or larger than the footprint surface area.

The adhesion layer may at least be located below the footprint of the 3D item. Thus, underneath the positions where the 3D item would contact the receiver item if the adhesion layer were not present. Having an adhesion layer located only below the footprint of the 3D item may minimize waste. However, the adhesion layer may also cover a larger area of the receiver item. An adhesion layer covering a larger area of the receiver item may be more useful for printing different types of 3D items on the same adhesion layer.

The 3D item manufactured using the method of this invention may have a footprint, wherein the footprint comprises a residue of the adhesion layer.

The first and second 3D printable material are not compatible, do not mix, and do not form a bond. However, the first 3D printable material of the adhesion layer may leave a residue or traces of the adhesion layer on the 3D item after separating the adhesion layer from the 3D item. This residue may be detected, for example using a microscope, and subsequently may be analyzed and characterized using material analysis methods.

Furthermore, the bottom layer of the 3D item, which has been in contact with the adhesion layer, will exhibit a curved shape due to its incompatibility with the adhesion layer.

As indicated above, the 3D printed item maybe used for different purposes. Amongst others, the 3D printed item maybe used in lighting. Hence, in yet a further aspect the invention also provides a lighting device comprising the 3D item as defined herein. In a specific aspect the invention provides a lighting system comprising (a) a light source configured to provide (visible) light source light and (b) the 3D item as defined herein, wherein 3D item may be configured as one or more of (i) at least part of a housing, (ii) at least part of a wall of a lighting chamber, and (iii) a functional component, wherein the functional component may be selected from the group consisting of an optical component, a support, an electrically insulating component, an electrically conductive component, a thermally insulating component, and a thermally conductive component. Hence, in specific examples the 3D item may be configured as one or more of (i) at least part of a lighting device housing, (ii) at least part of a wall of a lighting chamber, and (iii) an optical element. As a relative smooth surface may be provided, the 3D printed item may be used as mirror or lens, etc. In examples, the 3D item may be configured as shade. A device or system may comprise a plurality of different 3D printed items, having different functionalities. The 3D printed item may be used for many different purposes and in many different environments, such as indoor lighting, outdoor lighting, or automotive lighting.

The printer nozzle may include a single opening. In other embodiments, the printer nozzle may be of the core-shell type, having two (or more) openings. The term “printer head” may also refer to a plurality of (different) printer heads; hence, the term “printer nozzle” may also refer to a plurality of (different) printer nozzles.

The 3D printable material providing device may provide a filament comprising 3D printable material to the printer head or may provide the 3D printable material as such, with the printer head creating the filament comprising 3D printable material.

Especially, the 3D printer may comprise a controller (or is functionally coupled to a controller) that is configured to execute in a controlling mode (or “operation mode”) the method as described herein. Instead of the term “controller” also the term “control system” may be applied. The controller may be configured to control the controller.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc.

Hence, the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, WIFI, LiFi, ZigBee, BLE or WiMAX, or another wireless technology.

The system, or apparatus, or device may execute an action in a “mode” or “operation mode” or “mode of operation”. Likewise, in a method an action or stage, or step may be executed in a “mode” or “operation mode” or “mode of operation” or “operational mode”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

Hence, the control system may control in dependence of one or more of an input signal of a user interface, a sensor signal (of a sensor), and a timer. The term “timer” may refer to a clock and/or a predetermined time scheme.

Instead of the term “fused deposition modeling (FDM) 3D printer” shortly the terms “3D printer”, “FDM printer” or “printer” may be used. The printer nozzle may also be indicated as “nozzle” or sometimes as “extruder nozzle”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some general aspects of the 3D printer and of an embodiment of 3D printed material;

FIG. 2 depicts an overview of the method steps;

FIGS. 3a-3c schematically depict some examples of the method;

FIG. 4 schematically shows a top view of the receiver item;

FIGS. 5a-5b schematically depict aspects of the invention; and

FIG. 6 schematically depicts an application.

The schematic drawings are not necessarily to scale.

### DETAILED DESCRIPTION OF THE EMBODIMENTS

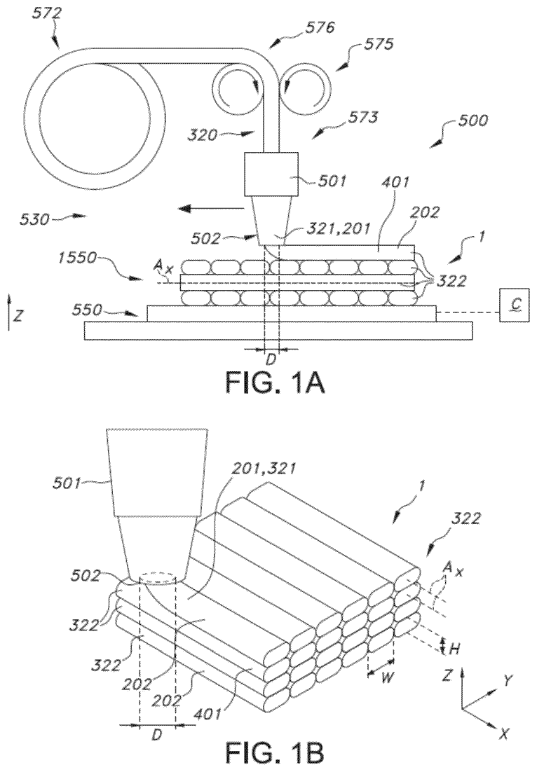

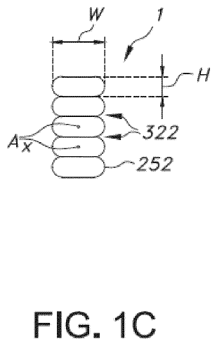

FIG. 1a schematically depicts some aspects of the 3D printer. Reference 500 indicates a 3D printer. Reference 530 indicates the functional unit configured to 3D print, especially FDM 3D printing; this reference may also indicate the 3D printing stage unit. Here, only the printer head for providing 3D printed material, such as an FDM 3D printer head is schematically depicted. Reference 501 indicates the printer head. The 3D printer of the present invention may especially include a plurality of printer heads (see below). Reference 502 indicates a printer nozzle. The 3D printer of the present invention may especially include a plurality of printer nozzles, though other embodiments are also possible. Reference 320 indicates a filament of printable 3D printable material (such as indicated above).

Instead of a filament also pellets may be used as 3D printable material. Both can be extruded via the printer nozzle.

For the sake of clarity, not all features of the 3D printer have been depicted, only those that are of especial relevance for the present invention (see further also below). Reference 321 indicates extrudate (of 3D printable material 201).

The 3D printer 500 is configured to generate a 3D item 1 by layer-wise depositing on a receiver item 550, which may in embodiments at least temporarily be cooled, a plurality of layers 322 wherein each layers 322 comprises 3D printable material 201, such as having a melting point Tₘ. The 3D printable material 201 may be deposited on a substrate 1550 (during the printing stage). By deposition, the 3D printable material 201 has become 3D printed material 202. 3D printable material 201 escaping from the nozzle 502 is also indicated as extrudate 321. Reference 401 indicates thermoplastic material.

The 3D printer 500 may be configured to heat the filament 320 material upstream of the printer nozzle 502. This may e.g. be done with a device comprising one or more of an extrusion and/or heating function. Such device is indicated with reference 573, and is arranged upstream from the printer nozzle 502 (i.e. in time before the filament material leaves the printer nozzle 502). The printer head 501 may (thus) include a liquefier or heater. Reference 201 indicates printable material. When deposited, this material is indicated as (3D) printed material, which is indicated with reference 202.

Reference 572 indicates a spool or roller with material, especially in the form of a wire, which may be indicated as filament 320. The 3D printer 500 transforms this in an extrudate 321 downstream of the printer nozzle which becomes a layer 322 on the receiver item or on already deposited printed material. In general, the diameter of the extrudate 321 downstream of the nozzle 502 is reduced relative to the diameter of the filament 320 upstream of the printer head 501. Hence, the printer nozzle is sometimes (also) indicated as extruder nozzle. Arranging layer 322 by layer 322, a 3D item 1 may be formed. Reference 575 indicates the filament providing device, which here amongst others include the spool or roller and the driver wheels, indicated with reference 576.

Reference Ax indicates a longitudinal axis or filament axis.

Reference 300 schematically depicts a control system. The control system may be configured to control the 3D printer 500. The control system 300 may be comprised or functionally coupled to the 3D printer 500. The control system 300 may further comprise or be functionally coupled to a temperature control system configured to control the temperature of the receiver item 550 and/or of the printer head 501. Such temperature control system may include a heater which is able to heat the receiver item 550 to at least a temperature of 50 °C, but especially up to a range of about 350 °C, such as at least 200 °C.

Alternatively or additionally, the receiver plate may also be moveable in one or two directions in the x-y plane (horizontal plane). Further, alternatively or additionally, in embodiments the receiver plate may also be rotatable about z axis (vertical). Hence, the control system may move the receiver plate in one or more of the x-direction, y-direction, and z-direction.

Alternatively, the printer can have a head can also rotate during printing. Such a printer has an advantage that the printed material cannot rotate during printing.

Layers are indicated with reference 322, and have a layer height H and a layer width W.

Note that the 3D printable material is not necessarily provided as filament 320 to the printer head. Further, the filament 320 may also be produced in the 3D printer 500 from pieces of 3D printable material. Hence, the nozzle 502 may effectively produce from particulate 3D printable material 201 a filament 320, which upon deposition is indicated as layer 322 (comprising 3D printed material 202). Note that during printing the shape of the extrudate may further be changes, e.g. due to the nozzle smearing out the 3D printable material 201/3D printed material 202. FIG. 1b schematically depicts that also particulate 3D printable material 201 may be used as feed to the printer nozzle 502.

Reference D indicates the diameter of the nozzle (through which the 3D printable material 201 is forced). However, the nozzle is not necessarily circular.

FIG. 1b schematically depicts in 3D in more detail the printing of the 3D item 1 under construction. Here, in this schematic drawing the ends of the layers in a single plane are not interconnected, though in reality this may in embodiments be the case.

Reference H indicates the height of a layer. Layers are indicated with reference 322. Here, the layers have a flattened, cross-section such as having an outer shape resembling a flat oval tube or flat oval duct (i.e. a circular shaped bar having a diameter that is compressed to have a smaller height than width, wherein the sides (defining the width) are (still) rounded).

Hence, FIG. 1a schematically depict some aspects of a fused deposition modeling 3D printer 500, comprising (a) a first printer head 501 comprising a printer nozzle 502, (b) a filament providing device 575 configured to provide a filament 320 comprising 3D printable material 201 to the first printer head 501, and optionally (c) a receiver item 550, which can be used to provide a layer of 3D printed material 202.

FIG. 1b schematically depict some aspects of a fused deposition modeling 3D printer 500 (or part thereof), comprising a first printer head 501 comprising a printer nozzle 502, and optionally a receiver item (not depicted), which can be used to which can be used to provide a layer of 3D printed material 202. Such fused deposition modeling 3D printer 500 may further comprise a 3D printable material providing device, configured to provide the 3D printable material 201 to the first printer head.

In FIGS. 1a-1b, the first or second printable material or the first or second printed material are indicated with the general indications printable material 201 and printed material 202, respectively. Downstream of the nozzle 502, the filament 320 with 3D printable material becomes, when deposited, layer 322 with 3D printed material 202. In FIG. 1b, by way of example the extrudate is essentially directly the layer 322 of 3D printed material 202, due to the short distance between the nozzle 502 and the 3D printed material (or receiver item (not depicted).

FIG. 1c schematically depicts a stack of 3D printed layers 322, each having a layer height H and a layer width W. Note that in embodiments the layer width and/or layer height may differ for two or more layers 322. The layer width and/or layer height may also vary within a layer. Reference 252 in FIG. 1c indicates the item surface of the 3D item (schematically depicted in FIG. 1c).

Referring to FIGS. 1a-1c, the filament of 3D printable material that is deposited leads to a layer having a height H (and width W). Depositing layer 322 after layer 322, the 3D item 1 is generated. FIG. 1c very schematically depicts a single-walled 3D item 1.

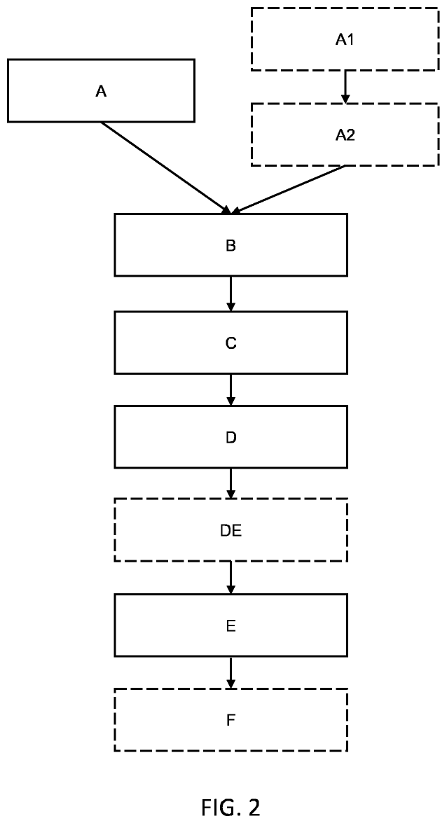

FIG. 2 shows an overview of the steps of the method. In step A, the receiver item 550 having an adhesion layer 222 is provided. The adhesion layer 222 is made of a first 3D printable material 201, the first 3D printable material 201 comprising a thermoplastic amorphous polymer having a first glass transition temperature TG1. Alternatively, the receiver item 550 having the adhesion layer may also be provided by following steps A1 and A2. Step A1 comprises selecting a first receiver item temperature TR1 which is higher than the first glass transition temperature TG1. Step A2 comprises depositing a layer 222 of first 3D printable material 201 on the receiver item 550 to provide the adhesion layer 222. Thus, for the method of this invention, either a receiver item 550 which does already have an adhesion layer 222, such as a coating, a lamination, or a previously printed adhesion layer 222, can be used. Alternatively, an adhesion layer 222 may be created as step A2 of the method using the 3D printer 500 by printing the first 3D printable material onto the receiver item 550 to form the adhesion layer 222 on the receiver item 550.

In step B, a second receiver item temperature is selected, which is above the first glass transition temperature, but may be lower than the first receiver item temperature. This step ensures that the adhesion layer 222 is in a tacky or rubbery state and prepared for printing the 3D item 1 on top of the adhesion layer. A receiver item temperature above the first glass transition temperature is required. Receiver item temperatures far above the first glass transition temperature may not be desired, since the adhesion layer may become too fluid and heating the receiver item to high temperatures may waste energy.

Subsequently in step C, the 3D item 1 is printed on top of the adhesion layer 220 using a second 3D printable material 201. Step C may be described as a standard 3D printing stage for creating the 3D item 1, with the difference that the 3D item 1 is printed on top of the immiscible adhesion layer 222.

Essentially, the method of the invention comprises providing a universal method to obtain the desired adhesive properties as indicated above based on compatibility of polymers. In the field of polymer science, the term compatibility is often used referring to miscibility of polymer mixtures. The miscibility of polymer pairs may be experimentally determined by making a binary phase diagram. Binary phase diagrams are well established in the art and documented for many different polymer pairs. Miscibility of polymers may also be theoretically calculated from known parameters of a polymer.

As already mentioned, the first and second 3D printable materials are not compatible or immiscible. Thus, the two 3D printable materials do not mix and do not form a chemical bond. The two materials do, however, adhere to each other during printing while the adhesion layer 222 has a temperature above the first glass transition temperature. At temperatures above the glass transition temperature, the adhesion layer 222 may be in a tacky state having a sticky consistency. The adhesion of the adhesion layer 222 to the 3D item 1 may be based on weak mechanical adhesion such as van der Waals forces, molecular attractions that operate over very small distances. The tacky texture of the adhesion layer 222 may maximize the contact surface with the 3D item 1 and may therewith provide an amount of adhesion which is sufficient to secure the 3D item 1 in place during printing.

Once printing of the 3D item 1 is completed, the receiver item 550 is cooled down to a third receiver item temperature in step D. The third receiver item temperature is lower than the first glass transition temperature to allow for the adhesion layer to solidify and transfer to its glassy state. Cooling down to a third receiver item temperature may for example happen by active cooling of the receiver item 550. Alternatively, the receiver item 550 may be allowed to cool down passively, such as by merely turning off the heating function of the receiver item 550.

In step E, the 3D item 1 may subsequently be removed from the adhesion layer 222. After the adhesion layer 222 and the 3D item 1 have cooled down to temperatures below the glass transition temperatures, both 3D printable materials are solid. Due to the incompatibility of the first and second 3D printable material, the two materials did not mix and did not bond chemically. Thus, the 3D item 1 can be separated from the adhesion layer 222 without problems. The adhesion layer 222 may remain on the receiver item 550 for printing a next 3D item 1. The reusability of the adhesion layer 222 may be improved by increasing the degree of adhesion of the receiver item 550 to the adhesion layer 222. This may for example be achieved by increasing the surface roughness of the receiver item 550 such that mechanical adhesion between the receiver item 550 and the adhesion layer 222 is achieved. In this way the adhesion layer 220 may show increased adherence to the receiver item 550 even after cooling below TG1.

Optionally in step F, the adhesion layer 222 may be removed from the receiver item 550 as well after removing the 3D item 1. Optionally and alternatively, the method may comprise step DE. In step DE, the adhesion layer 222 may be removed from the receiver item 550 before removing the 3D item 1. Thus, when removing the adhesion layer 222 from the receiver item 550 the adhesion layer 222 may be connected to the 3D item 1. Subsequently, the adhesion layer 222 is separated from the 3D item 1.

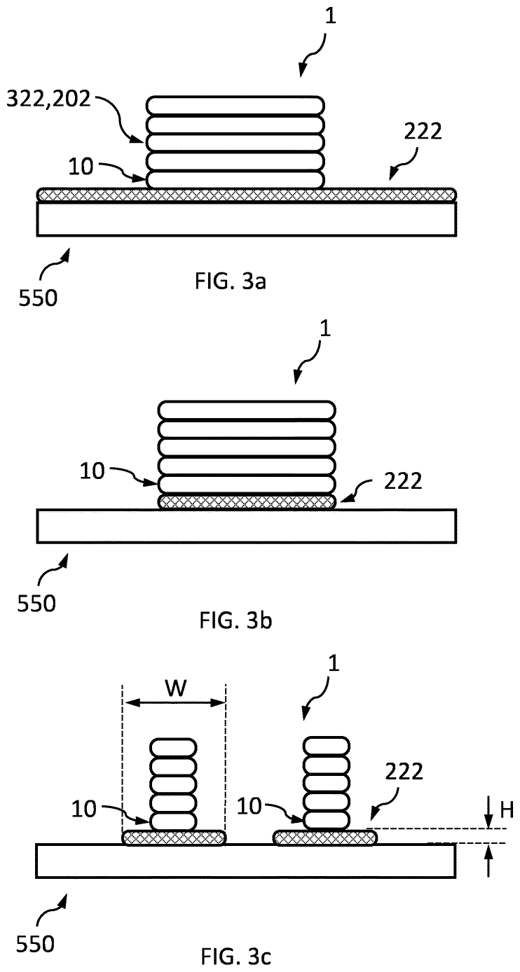

FIGS. 3a-3c schematically depict examples of the method, more specifically of potential different implementations of the adhesion layer 222. However, other implementations are also possible. The examples depict the receiver item 550 with the adhesion layer 222 and the 3D item 1. The 3D item 1 is created by layer-wise depositing 3D printable material 201, to provide the 3D item 1 comprising 3D printed material 202 on a receiver item 550. The 3D item 1 may especially comprise a plurality of layers 322 of 3D printed material 202. The receiver item 550 has a receiver item surface area and the adhesion layer 222 covers a first surface area of the receiver item surface area. The first surface area may be smaller than the receiver item surface area or equal to the receiver item surface area. The first surface area may be equal to the footprint 10 surface area or may be larger than the footprint surface area.

The method comprises providing a receiver item 550 having an adhesion layer 222 made of a first 3D printable material 201. The receiver item 550 may have a coating of or may be laminated with the first 3D printable material, which may cover the whole top surface of the receiver item 550. The adhesion layer 222 may also be deposited on the receiver item 550 using the 3D printer 500 and the first 3D printable material 201 to provide an adhesion layer 222 which may cover the complete top surface of the receiver item. Such an example in which the adhesion layer 222 covers the receiver item 550 for 100% is shown in FIG. 3 a. This implementation may provide the flexibility to print different types of 3D items 1 having different footprints 10 on the same adhesion layer 222.

The footprint 10 of the 3D item 1 is the area described by the first layer or the bottom layer of the 3D item 1, thus the footprint 10 has a footprint surface area. The footprint 10 of the 3D item 1 are the positions where the 3D item 1 would contact the receiver item 550 if the adhesion layer 222 was not present.

FIG. 3b shows an example in which the adhesion layer 222 is dimensioned such that it covers the footprint 10 of the 3D item 1 and is equal to the footprint surface area. The adhesion layer 222 may cover at least the footprint surface area. Hence, the footprint 10 of the 3D item 1 may be in contact with the adhesion layer 222 in all positions and may not be in direct contact with the receiver item 550 in any position. Thus, ensuring a good adhesion to the adhesion layer 222 as well as a convenient removal of the 3D item 1 after printing. In such an implementation the adhesion layer 222 may be specifically suited for one footprint 10 of one 3D item 1 and may not be reused for other types of 3D items 1. However, it may use the smallest possible amount of first 3D printable material to minimize waste.

FIG. 3c shows another example, in which the adhesion layer 222 covers a first surface area which may be larger than the footprint 10 of the 3D item 1, but smaller than the whole surface area of the receiver item 550. The adhesion layer 222 may be described by its height H and its width W. The adhesion layer 222 may have a width W and the ratio of width versus height may be at least 10. The adhesion layer 222 may also be described by the size of its first surface area in relation to the footprint 10 surface area. The first surface area may be at least 1.5 times the footprint surface area, such as at least 2 times, preferably at least 3 times the footprint surface area.

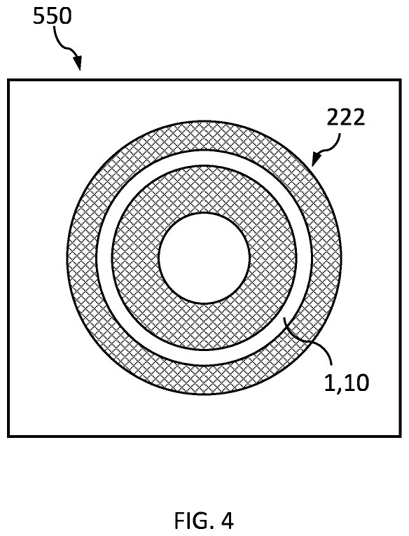

FIG. 4 schematically depicts a top view on the receiver item to illustrate an example of a 3D item 1 on an adhesion layer 222. As mentioned above, the receiver item 550 may have a receiver item surface area, and the 3D item 1 may have a footprint 10 having a footprint surface area. The adhesion layer 222 may cover a first surface area of the receiver item surface area. In this example, the first surface area is larger than the footprint surface area but smaller than the receiver item surface area.

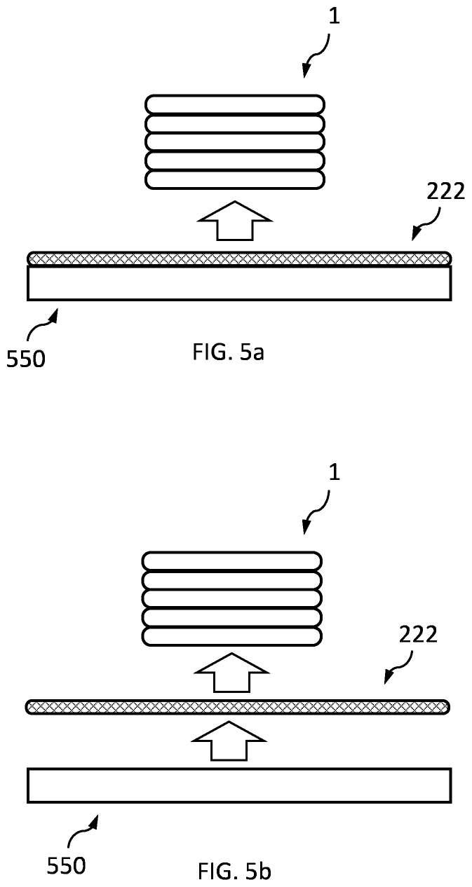

FIGS. 5a-5b schematically illustrate the removal of the 3D item 1 after printing. FIG. 5a shows removal of the 3D item 1 from the adhesion layer 222. The adhesion layer 222 remains on the receiver item 550, ready to be reused for the next print cycle to create the following 3D item. As already indicated above, the adhesion layer 222 may also be removed from the receiver 550 after printing, either together with the 3D item 1 or after the 3D item 1 has been removed. Reasons to remove the current adhesion layer 222 may include that the adhesion layer 222 has been damaged, that the adhesion layer 222 does not have suitable dimensions for the next to be printed 3D item 1, or that the adhesion layer 222 is not made of a suitable material for the next 3D Item 1.

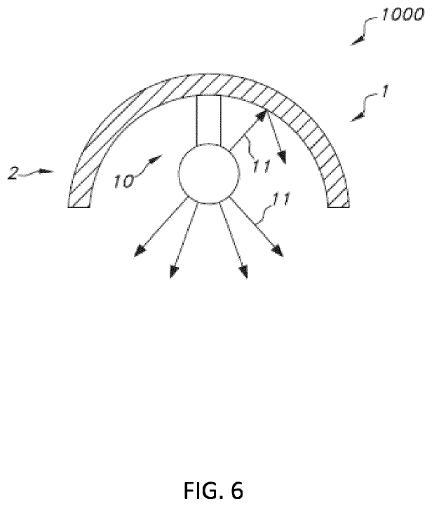

FIG. 6 schematically depicts an example of a lamp or luminaire 2, which comprises a light source 10 for generating light 11. The lamp 2 may comprise a housing or shade or another element, which may comprise or be the 3D printed item 1. Here, the half sphere (in cross-sectional view) schematically indicates a housing or shade. The lamp or luminaire 2 may be or may comprise a lighting device 1000 (which comprises the light source 10). Hence, the lighting device 1000 comprises the 3D item 1. The 3D item 1 may be configured as one or more of (i) at least part of a lighting device housing, (ii) at least part of a wall of a lighting chamber, and (iii) an optical element. Hence, the 3D item 1 may be reflective for light source light 11 and/or transmissive for light source light 11. Here, the 3D item 1 may e.g. be a housing or shade.

The invention also provides a receiver item 550 having a coating of an amorphous polymer. The invention additionally relates to a 3D printer 500 comprising the receiver item 550 having a coating of an amorphous polymer and comprising two feeders 575 to feed two different 3D printable materials 201 from two different reels 572 to one or two different nozzles 502. The first feeder 575 may provide the first 3D printable material 201 for printing the adhesion layer 222. The second feeder 575 may provide the second 3D printable material 201 for printing the 3D item 1.

The invention additionally relates to a computer program product comprising instructions which, when the computer program product is executed by a computer which is functionally coupled to or comprised by a 3D printer 500 described above, cause the 3D printer 500 to carry out the method of this invention.

The computer program may calculate the footprint 10 of the 3D item 1 to be printed. It may calculate the design of the first layer 322 and the adhesion layer 222. The computer program may be set such that an adhesion layer 222 may be printed which area is adapted to the bottom shape of the 3D item 1.

Essentially, the method of the invention comprises providing a universal method for providing good adhesion of polymers to the receiver item during printing based on immiscibility of polymers. Experiments have been performed with numerous different printing materials of which a few examples are described in more detail hereafter. It should be noted that these are examples of different combinations of incompatible first 3D printable material and second 3D printable material, and that the skilled person is able to design alternatives without departing from the scope of the appended claims.

In a first experiment, the first 3D printable material 201 comprised by the adhesion layer 222 is PLA. The second 3D printable material 201 comprised by the 3D item 1 is PA6 (nylon). Nylon has a melting temperature above 200 °C, which traditionally makes adhesion to the receiver item 550 during printing challenging. The PLA adhesion layer 222 is printed using a nozzle temperature of 220 °C and a first receiver item temperature of 130 °C The second receiver item temperature is 110 °C and the 3D item made of PA6 is printed using a nozzle temperature of 270 °C.

In a second experiment, the first 3D printable material comprised by the adhesion layer 222 is PET, in combination with PA6 as second 3D printable material. The adhesion layer 222 is printed at a nozzle temperature of 260 °C and a first receiver item temperature of 130 °C. The second receiver item temperature is 80 °C.

In a third experiment, the first 3D printable material comprised by the adhesion layer 222 is polystyrene (PS). The second 3D printable material used for printing the 3D item 1 is polypropylene (PP). The adhesion layer 222 is printed at a nozzle temperature of 280 °C and a first receiver item temperature of 140 °C. The second receiver item temperature is 110 °C and the second 3D printable material is printed using a nozzle temperature of 310 °C.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” includes also embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

It goes without saying that one or more of the first (printable or printed) material and second (printable or printed) material may contain fillers such as glass and fibers which do not have (to have) influence on the on T_{g} or Tₘ of the material(s).

1. A method of manufacturing a 3D item by means of 3D printing using a 3D printer, wherein the 3D printer has a receiver item which can be heated to a receiver item temperature,
wherein the method comprises the steps of:
providing the receiver item having an adhesion layer made of a first 3D printable material, the first 3D printable material comprising a thermoplastic amorphous polymer having a first glass transition temperature TG1;
heating the receiver item to a second receiver item temperature TR2 above the first glass transition temperature TG1; and
printing the 3D item on top of the adhesion layer using a second 3D printable material, the second 3D printable material comprising a thermoplastic polymer having a second glass transition temperature TG2 and/or a second melting temperature TM2, wherein TG2>TR2>TG1 and/or TM2>TR2>TG1, and
the second 3D printable material being non-miscible with the first 3D printable material;
cooling down the receiver item to a third receiver item temperature TR3, wherein TR3<TG1; and
removing the 3D item from the adhesion layer.

2. The method according to claim 1, wherein the step of providing the receiver item having the adhesion layer consists of two steps comprising:
heating the receiver item to a first receiver item temperature TR1, wherein TR1≥TR2>TG1, and
depositing a layer of first 3D printable material on the receiver item to provide the adhesion layer.

3. The method according to claim 2, wherein TR1≥TR2+10 °C.

4. The method according to claim 1, wherein the method additionally comprises:
removing the adhesion layer from the receiver item after removing the 3D item.

5. The method according to claim 1, wherein, prior to removing the 3D item from the adhesion layer, the method additionally comprises the step of:
removing the adhesion layer from the receiver item, wherein the adhesion layer is connected to the 3D item.

6. The method according to claim 1, wherein the adhesion layer has a height H, wherein H≤3 mm.

7. The method according to claim 6, wherein the adhesion layer has a width W and wherein W/H is at least 10.

8. The method according to claim 1, wherein the second receiver item temperature TR2 is at least 5 °C above the first glass transition temperature TG1.

9. The method according to claim 1, wherein the second glass transition temperature TG2 and/or the second melting temperature TM2 is above 120 °C, and wherein TG2−TG1≥30 °C and/or TM2−TG1≥30 °C.

10. The method according to claim 1, wherein one of the first 3D printable material and the second 3D printable material is a polar polymer, and the other is a non-polar polymer.

11. The method according to claim 1, wherein the first 3D printable material and the second 3D printable material are semicrystalline polymers.

12. The method according to claim 1, wherein the first 3D printable material comprises one or more of PLA, PET, PC, PS, or PMMA and their co-polymers, and/or wherein the second 3D printable material comprises one or more of polyamide (nylon PA6), PP, PE, or PHA.

13. The method according to claim 1, wherein the receiver item has a receiver item surface area SAr, wherein the 3D item has a footprint having a footprint surface area SAfp, wherein the adhesion layer covers a first surface area SA1 of the receiver item surface area SAr, wherein SA1≤SAr, and wherein SA1=SAfp or SA1>SAfp.

14. A 3D item manufactured using the method according to claim 1, wherein the 3D item has a footprint, wherein the footprint comprises residues of the adhesion layer.

15. A lighting device comprising the 3D item according to claim 14, wherein the 3D item is configured as one or more of (i) at least part of a lighting device housing, (ii) at least part of a wall of a lighting chamber, and (iii) an optical element.
